(19) United States
(12) Patent Application Publication
(10) Pub. No.: US 2003/0188605 A1
(43) Pub. Date: Oct. 9, 2003

(54) Hand tool with three connecting bodies for screwedly locking other tools

(76) Inventor: Tsung-Chieh Chang, Taipei (TW)

Correspondence Address: Tsung-Chieh Chang, 235 Chung-Ho, Box 8-24, Taipei, TW

(21) Appl. No.: 10/118,198

(22) Filed: Apr. 9, 2002

(51) Int. Cl. B25B 13/46

(52) U.S. Cl. 81/60

(57) ABSTRACT

A hand tool with three connecting bodies comprises a handle body and at least two connecting bodies for being connected to screwing tools. The handle body is an approximate T shape body. Two ends thereof are installed with a first connecting body and a second connecting body. The handle body has a cruciform-like pivotal hole. A center of the hole is vertical to an axis of the handle body. A cruciform-like pivotal elastomer is tightly engaged in the pivotal hole. A third connecting body has a pivotal end. The pivotal end of the third connecting body is inserted into the pivotal hole. Thereby, the first, second and third connecting bodies are capable of being engaged with sleeve form openers, hexagonal openers and other screwing tools.

### FIELD OF THE INVENTION

The present invention relates to hand tools, and particularly to a hand tool with three connecting bodies for screwedly locking with other tools.

### BACKGROUND OF THE INVENTION

Types of general hand tools for locking screws, nuts, studs, and other screwing means include cruciform form types, sleeve form types, inner hexagonal screw rod types, and ratchet types. The prior art hand tool is generally suitable for only one type. However, in general, in a working process, many different forms of hand tools are necessary for being connected with other tools, such as openers. Although some commercial hand tools may combine a screw driver with a sleeve, the types of the screw driver and sleeve in these prior arts are predetermined and can not be updated as desired. Therefore, there is an eager demand for a novel hand tool which can improve the defects in the prior art.

### SUMMARY OF THE INVENTION

Accordingly, the primary object of the present invention is to provide a hand tool with three connecting bodies, wherein the connecting bodies can be locked with various type of screwing hand tools and be detached from the screwing hand tools.

To achieve above objects, the present invention provides a hand tool with three connecting bodies comprising a handle body and at least two connecting bodies for being connected to screwing tools. The handle body is an approximate T shape body; two ends thereof are installed with a first connecting body and a second connecting body; the handle body has a cruciform-like pivotal hole; a center of the hole is vertical to an axis of the handle body. A cruciform-like pivotal elastomer is tightly engaged in the pivotal hole. A third connecting body has a pivotal end. The pivotal end of the third connecting body is inserted into the pivotal hole. Thereby, the first, second and third connecting bodies are capable of being engaged with sleeve form openers, hexagonal openers and other screwing tools.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is an exploded perspective view of the present invention.

FIG. 3 is a partial schematic view of the present invention.

FIG. 4 shows another partial schematic view of the present invention.

FIG. 5 is a schematic view showing an application of the present invention.

FIG. 6 is a schematic view showing another application of the present invention.

FIG. 7 is a perspective view of another embodiment of the present invention.

FIG. 8 is an exploded perspective view of another embodiment of the present invention.

FIG. 9 is a partial schematic view of another embodiment of the present invention.

### DETAILED DESCRIPTION OF THE PREFERRED EMBODIMENTS

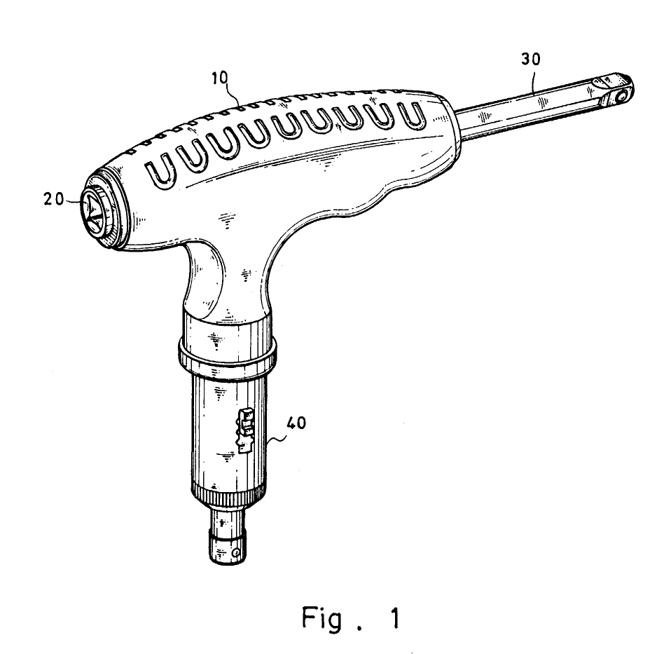

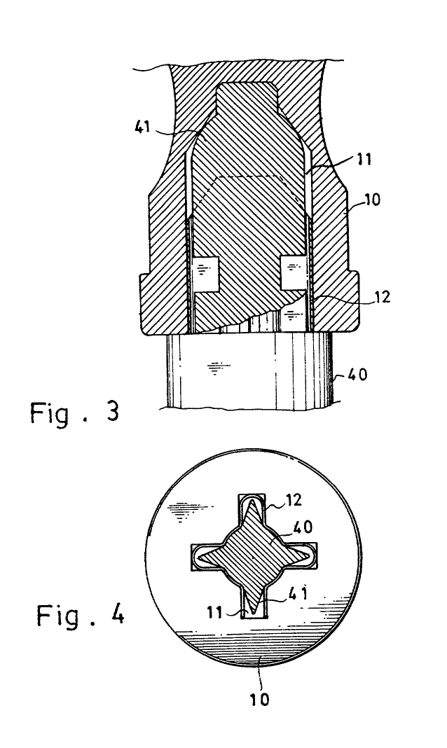

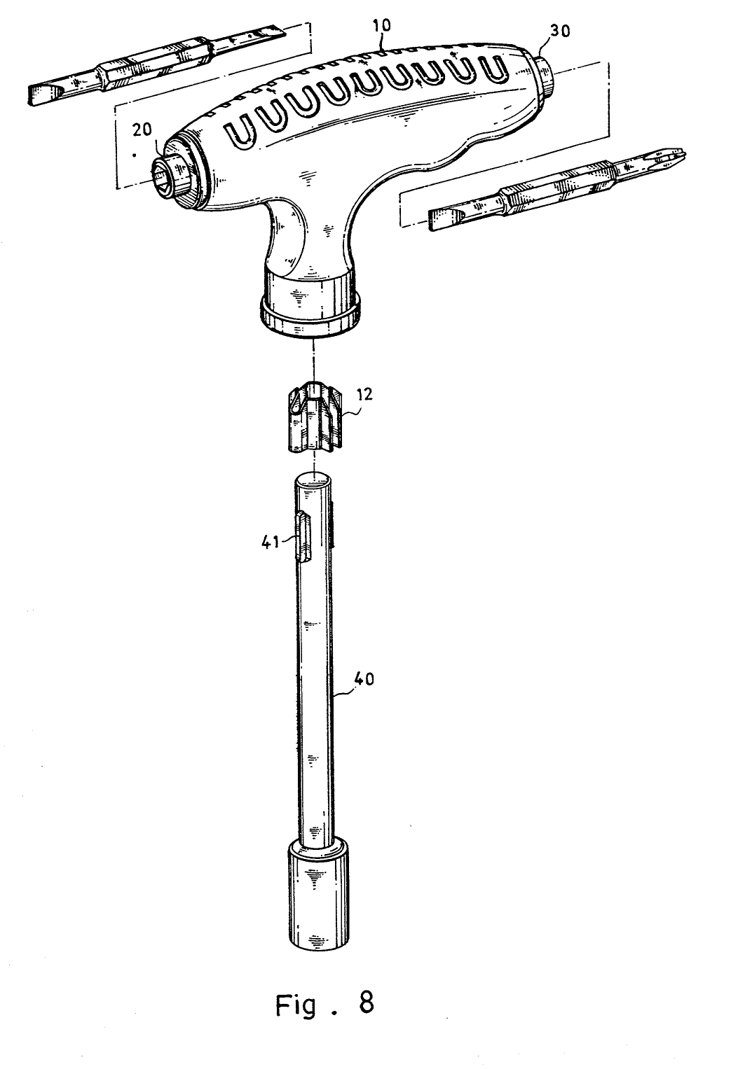

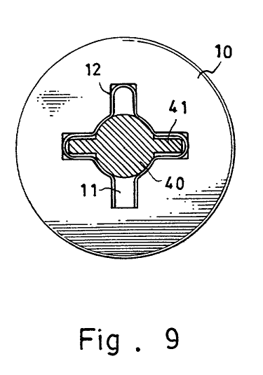

Referring to FIGS. 1 to 9, one embodiment of the present invention is illustrated. The embodiment described herein is only used as an example. Thereby, those skilled in the art can understand the present invention. However, the scope of the present invention is not confined by the embodiment, and this it can not be used to confine the scope and spirit of the present invention.

Referring to FIG. 1, the hand tool includes a handle body 10 and a plurality of connecting bodies 20, 30 and 40 for being connected to screwing tools.

The handle body 10 is an approximate T shape body. Two ends thereof are installed with a first connecting body 20 and a second connecting body 30. In this embodiment, the first connecting body 20 and the second connecting body 30 may be connected with ends of a sleeve 51.

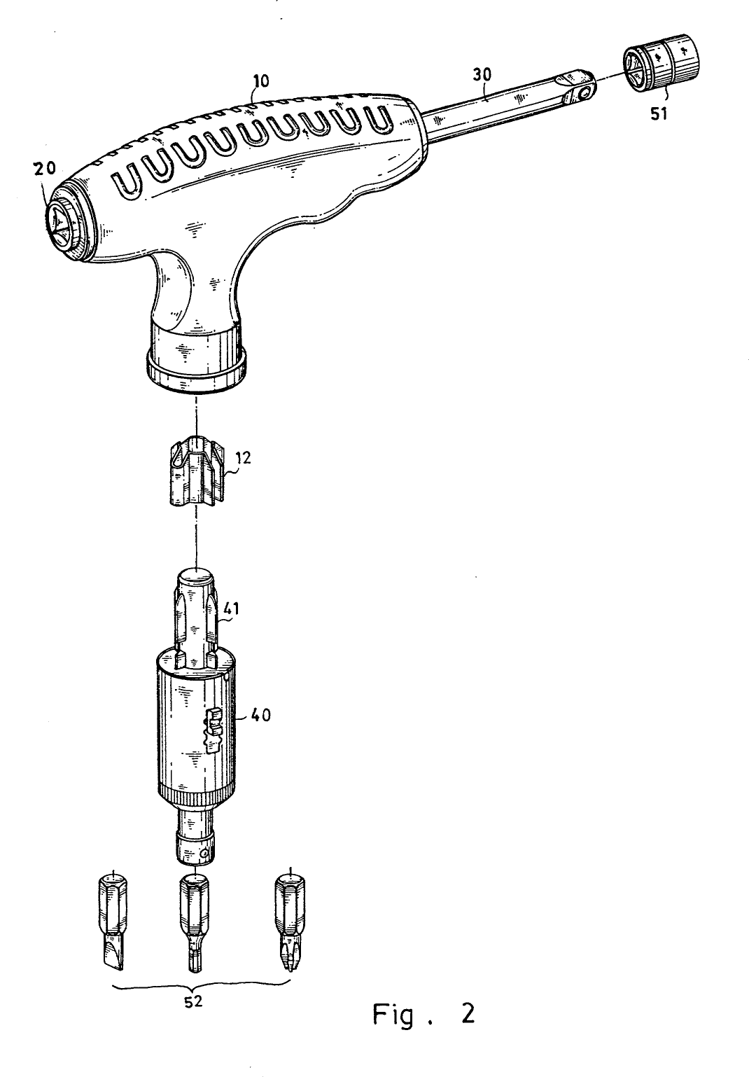

Referring to FIGS. 2 to 4, the handle body 10 has a cruciform-like pivotal hole 11. The center of the hole is vertical to the axis of the handle body 10. A cruciform-like pivotal elastomer 12 is tightly engaged in the pivotal hole 11. A third connecting body 40 has a pivotal end 41. The pivotal end 41 of the third connecting body 40 can be inserted into the pivotal hole 11. In this embodiment, the third connecting body 40 as a ratchet driver is used to connect a hexagonal opener 52. The structure of the ratchet driver (third connecting body 40) is known in the prior art and thus the detail will not be described further. The pivotal end 41 of the third connecting body 40 has a structure corresponding to the cruciform-like elastomer 12 and the cruciform-like pivotal hole 11. The third connecting body 40 can be assembled to and detached from the approximate cruciform pivotal hole.

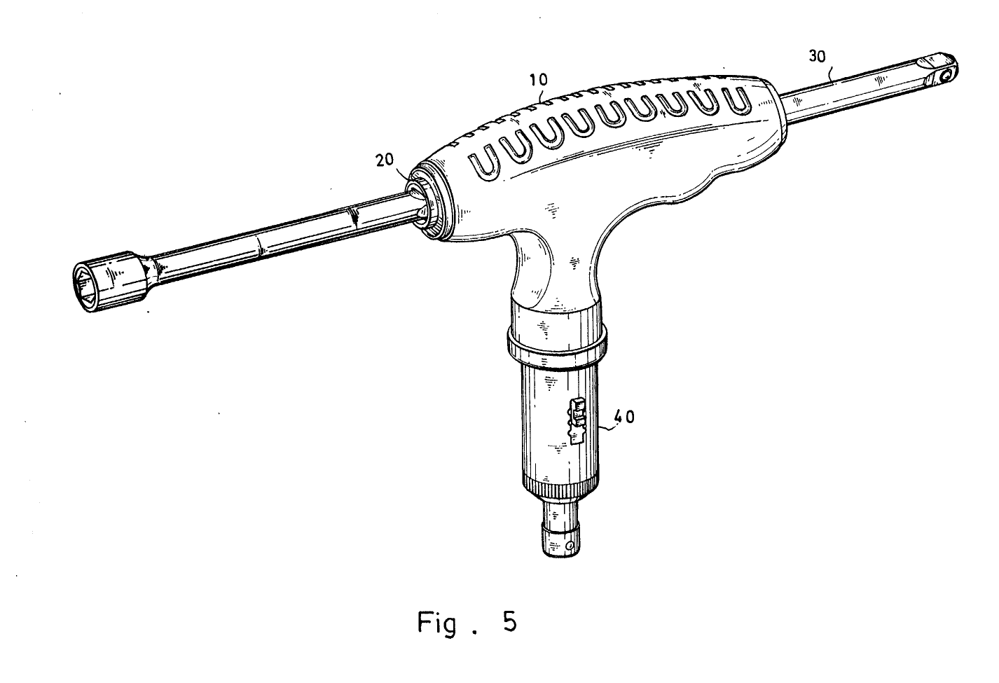

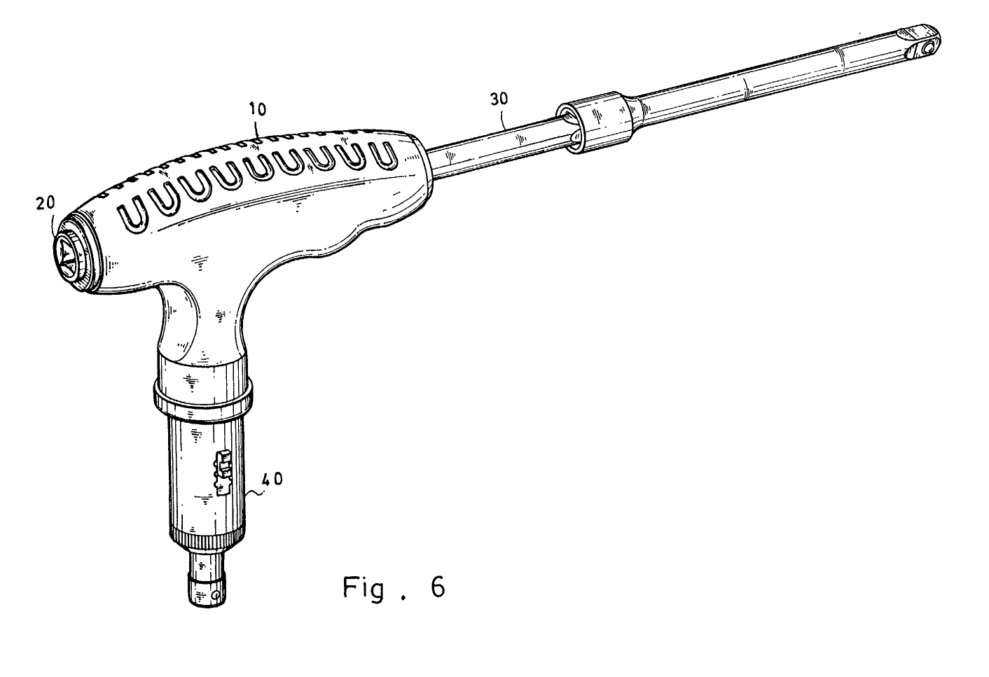

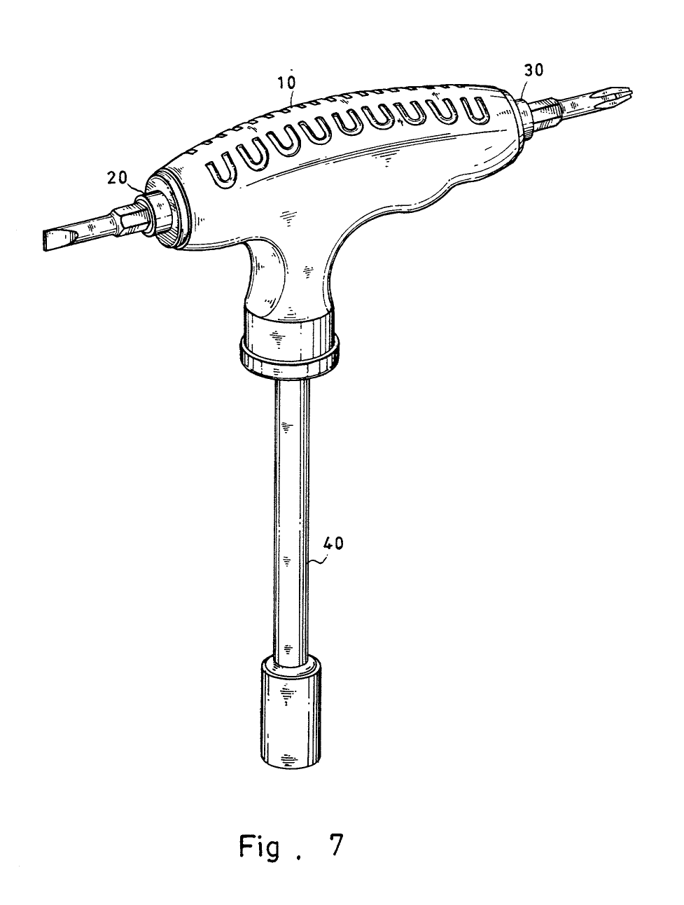

Referring to FIGS. 5 and 6, by above structure, the hand tool of the present invention is not only utilized to connect any screwing tool (such as sleeves, hexagonal screw heads, cruciform openers, etc.), but also the first and second connecting bodies 20 and 30 can be used to assemble other tools or be prolonged.

Furthermore, referring to FIGS. 7 to 9, in one application of the present invention, the first and second connecting bodies 20 and 30 are sleeves with hexagonal inner holes for being engaged with the openers 52 of various forms. The third connecting body 40 is formed for being connected to sleeve type opener or other connecting body. Moreover, the pivotal end 41 of the third connecting body 40 is installed with protruding pieces. The protruding pieces are exactly installed within the cruciform-like elastomer 12 of the cruciform-like pivotal hole 11. Thereby, third connecting body 40 can be attached or detached easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A hand tool with three connecting bodies comprising a handle body and at least two connecting bodies for connecting with screwing tools; characterized in that:
the handle body is a T shape-like body; two ends thereof are installed with a first connecting body and a second connecting body; the handle body has a cruciform-like pivotal hole; a center of the hole is vertical to an axis of the handle body; a cruciform-like pivotal elastomer is tightly engaged in the pivotal hole; a third connecting body has a pivotal end; the pivotal end of the third connecting body is inserted into the pivotal hole; thereby, the first, second and third connecting bodies are capable of being engaged with sleeve form openers, hexagonal openers and other screwing tools.

2. The hand tool with three connecting bodies as claimed in claim 1, wherein the pivotal end of the third connecting body has a structure corresponding to the cruciform-like elastomer and the cruciform-like pivotal hole; thereby, the third connecting body is capable of being assembled to and detached from the third connecting body.

3. A hand tool with three connecting bodies comprising a handle body and at least two connecting bodies for connecting with screwing tools; characterized in that:
the handle body is a T shape-like body; two ends thereof are installed with a first connecting body and a second connecting body; the handle body has a cruciform-like pivotal hole; a center of the hole is vertical to an axis of the handle body; a cruciform-like pivotal elastomer is tightly engaged in the pivotal hole; a third connecting body has a pivotal end; the pivotal end of the third connecting body is inserted into the pivotal hole; the third connecting body is a ratchet driver for being connected with a hexagonal opener; the pivotal end of the third connecting body has a structure corresponding to the cruciform-like elastomer and the cruciform-like pivotal hole; thereby, the third connecting body is capable of being assembled to and detached from the third connecting body;
thereby, the first, second and third connecting bodies are capable of being engaged with screwing tools.

4. A hand tool with three connecting bodies comprising a handle body and at least two connecting bodies for connecting with screwing tools; characterized in that:
the handle body is a T shape-like body; two ends thereof are installed with a first connecting body and a second connecting body; the handle body has a cruciform-like pivotal hole; a center of the hole is vertical to an axis of the handle body; a cruciform-like pivotal elastomer is tightly engaged in the pivotal hole; a third connecting body has a pivotal end; the pivotal end of the third connecting body is inserted into the pivotal hole; the first and second connecting bodies are connected to sleeves with hexagonal inner holes; and the third connecting body is used to be connected to a sleeve form opener and other types of openers.
